(19) United States
(12) Patent Application Publication
(10) Pub. No.: US 2005/0103688 A1
(43) Pub. Date: May 19, 2005

(54) External adjustment device for magnetic drum separators

(76) Inventor: Kevin R. McHenry, Jacksonville, FL (US)

Correspondence Address: Arthur G. Yeager, P.A., 245-1 East Adams Street, Jacksonville, FL, 32202-3336, US

(21) Appl. No.: 10/715,256

(22) Filed: Nov. 17, 2003

(51) Int. Cl. B03C 1/00

(52) U.S. Cl. 209/223.2

(57) ABSTRACT

The device adjusts clearance between a rotatable drum interior surface and an internal magnet array supported by a fixed shaft disposed inside such drum. The device includes a pair of hollow cylindrical sleeves disposed respectively between shaft end portions and drum end plates. Adjustment devices carried by each of the sleeves and located externally of the end plates vary the spatial distance between the sleeve interior surface and the outer surface of the shaft and for moving the drum longitudinal axis relative to the magnet array longitudinal axis to provide a generally uniform clearance space between the drum and magnet array outer surface. A plurality of spaced threaded radially disposed holes extend through the sleeve and a plurality of elongate screws are threaded into the holes and contact the shaft outer surface to move the respective sleeve with respect to the shaft for moving the drum longitudinal axis.

### CROSS REFERENCE TO RELATED APPLICATION

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to adjustment devices for wet and dry magnetic drum separators and particularly to external adjustment apparatus.

2. Relevant Art

A wide variety of adjustment devices exist for adjusting the clearance between the interior surface of a rotating drum and a stationary magnet array. What is desired is a device that provides for adjustment externally of the drum, especially in applications employing a wet drum separation system.

### BRIEF SUMMARY OF THE INVENTION

In one aspect of the present invention there is provided an adjustment apparatus for adjusting the clearance between the interior surface of a rotatable drum having spaced end plates connected to a cylindrical shell and a magnet array having an outer surface supported by a fixed shaft having an outer surface in a relatively fixed position and disposed inside such drum, the apparatus comprising a hollow cylindrical sleeve having interior and exterior surfaces and opposite end portions and means for mounting the sleeve between such shaft and one such end plate, the means for mounting includes adjustment means carried by the sleeve and located externally of the end plates for varying spatial distance between the interior surface of the sleeve and the outer surface of such shaft for moving the longitudinal axis of such drum relative to the longitudinal axis of such magnet array and to provide a generally uniform clearance space between the interior surface of such drum and an outer surface of such magnet array. The sleeve includes a plurality of spaced threaded radially disposed holes extending between the interior and exterior surfaces, and the adjustment means includes a plurality of elongate screws threaded into the holes and contacting the outer surface of such shaft, each screw being operable inwardly and outwardly in respective hole to move the sleeve with respect to such shaft for moving the longitudinal axis of such drum. The shaft has a plurality of flat surface areas formed on the outer surface thereof for engagement with a respective screw.

The means for mounting includes a bearing surface formed on one end portion of the sleeve for engagement with an end plate for supporting a drum thereon. The holes are spaced at approximately 60 degrees apart. The sleeve includes a first and second set of spaced radially disposed holes extending between the interior and exterior surfaces, the adjustment means including a plurality of elongate posts located in the first set of holes and contacting the outer surface of such shaft, each installed post operable inwardly and outwardly in respective hole to move the sleeve with respect to such shaft for vertically moving the longitudinal axis of such drum. The holes have internal threads and each post has external threads matching the threads in the holes.

In another aspect of the present invention there is provided adjustment apparatus for adjusting the clearance between the interior surface of a rotatable drum having spaced end plates connected to a cylindrical shell and a magnet array having an outer surface supported by a fixed shaft having an outer surface and opposite end portions in a relatively fixed position and disposed inside such drum, the apparatus comprising a pair of hollow cylindrical sleeves each having interior and exterior surfaces and opposite end portions and means for mounting each sleeve between one end portion of such shaft and one such end plate, the means for mounting including adjustment means carried by the sleeve and located externally of the end plates for varying spatial distance between the interior surface of the sleeve and the outer surface of a respective end portion of such shaft and for moving the longitudinal axis of such drum relative to the longitudinal axis of such magnet array and to provide a generally uniform clearance space between the interior surface of such drum and an outer surface of such magnet array. The sleeve includes a plurality of spaced threaded radially disposed holes extending between the interior and exterior surfaces, the adjustment means including a plurality of elongate screws threaded into the holes and contacting the outer surface of the end portion of such shaft, each screw operable inwardly and outwardly in respective hole to move respective sleeve with respect to such shaft for moving the longitudinal axis of such drum. The shaft has a plurality of flat surface areas formed on the outer surface thereof for engagement with a respective screw. The means for mounting includes a bearing surface formed on one end portion of each sleeve for engagement with an end plate for supporting a drum thereon. The holes are spaced circumferentially at approximately 60 degrees apart.

In a further aspect of the present invention there is provided adjustment apparatus for adjusting the clearance between an interior surface of a hollow drum rotatably mounted on a shaft having an outer surface, the drum having spaced end plates connected to a cylindrical shell and a magnet array supported by the shaft in a relatively fixed position with respect to the drum and shaft and disposed inside the drum, the apparatus comprising a pair of hollow cylindrical sleeves each having interior and exterior surfaces and opposite end portions and means for mounting the respective sleeve between the shaft and respective end plates. The means for mounting includes adjustment means carried by the sleeve and located externally of the end plates for varying spatial distance between the interior surface of the sleeve and the outer surface of the shaft and for moving the longitudinal axis of the drum relative to the longitudinal axis of the magnet array and to provide a generally uniform clearance space between the interior surface of the drum during its rotation with respect to an outer surface of the magnet array. The sleeve includes a plurality of spaced threaded radially disposed holes extending between the interior and exterior surfaces, the adjustment means including a plurality of elongate screws threaded into the holes and contacting the outer surface of the end portion of the shaft, each screw operable inwardly and outwardly in respective hole to move respective sleeve with respect to the shaft for moving the longitudinal axis of the drum. The shaft has a plurality of flat surface areas formed on the outer surface for engagement with a respective screw. The means for mounting includes a bearing surface formed on one end portion of each sleeve for engagement with the end plate for supporting the drum thereon. The holes are spaced circumferentially at approximately 60 degrees apart.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

FIG. 1 is an elevation view of the adjustment device in accord with the present invention;

FIG. 2 is an end view of the device of FIG. 1 secured to a drum shaft;

FIG. 3 is a side pictorial view of a magnetic drum separator apparatus employing the adjustment device of FIGS. 1 and 2; and

FIG. 4 is another view of the apparatus of FIG. 3 illustrating the position of a drum drive sprocket attached to the drum.

### DETAILED DESCRIPTION OF THE INVENTION

Introduction

In the production of high-intensity magnetic drum separators there is a need to place the internal magnet assembly as close as possible to the inside surface of the drum. Due to manufacturing tolerances this must be accomplished with an adjustment apparatus. This apparatus has always been located within the drum. That has necessitated access holes in the drum endplates and created a difficult, sometimes unsafe adjustment procedure. Further, in drums used for wet processing, the access holes in the endplates are unacceptable as they provide an inevitable leak path which will cause serious damage to the magnet assembly. This invention eliminates the need for these access holes.

The present apparatus provides a means of adjustment external to the drum. This results in an easier, safer adjustment procedure. The device is a hollow cylinder which has a section of the outer surface machined to create a bearing seat, and a series of threaded, radial holes which allow for jacking screws. These screws are used to position the cylinder relative to a shaft having machined flats on the outer surface, which supports the magnet assembly. An appropriate bearing is placed on the seat and the assembly is mated to a drum endplate. The drum and cylinders are coaxial. Thus the axis of the drum can be moved relative to the axis of the magnet assembly.

With respect now to the drawings, an adjustment cylinder or sleeve according to the present invention is shown at 10 in FIG. 1. Metal body 11 has an end portion machined to form a bearing seat 12 defining bearing flange 17 and another end portion 13. The cylinder 10 is a hollow member defined by interior surface 15 and interior passageway 14.

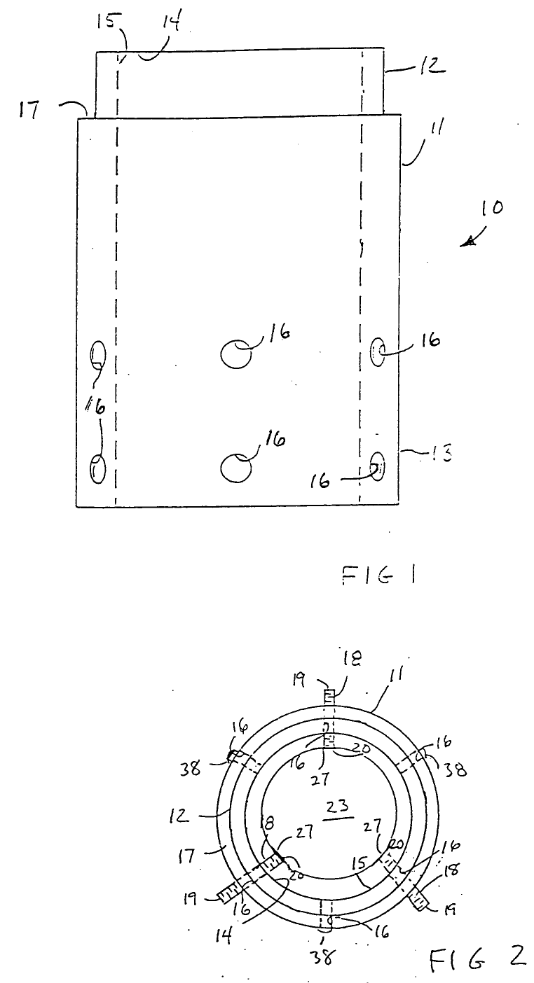

As illustrated in FIG. 2, six pairs of threaded radial holes 16 spaced 60 degrees apart pass into passageway 14. Jacking screws 18 are threaded through three pairs spaced 120 degrees apart of holes 16 by rotation of screw ends 19 to position the interior end 20 of screw 18 a desired distance into passageway 14 as will be discussed hereinbelow.

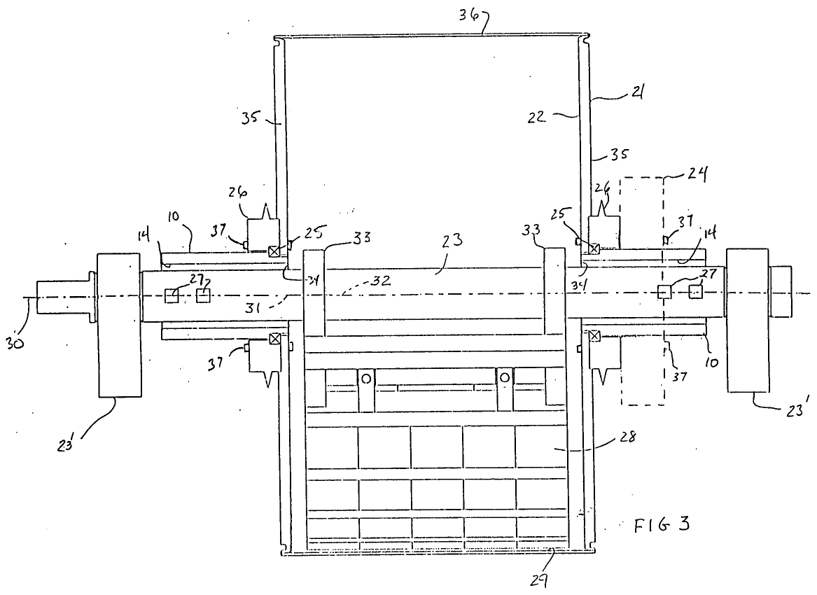

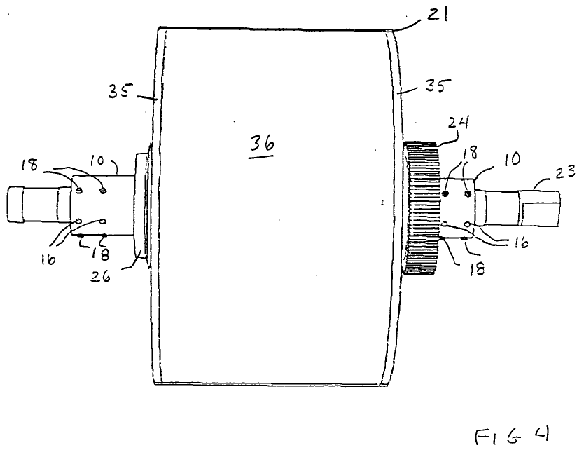

With regard to FIGS. 3 and 4, the sleeve 10 in use in magnetic drum separation apparatus is illustrated. The drum 21 is cylindrical in nature and includes an inside surface 22. Drum 21 is rotated via a drive sprocket 24 bolted to bearing cover 26 that is in turn bolted to drum 21 via bolts 37. Sleeve 10 is positioned within endplate opening 34 on bearing end 12.

Fixed shaft 23, mounted on supports 23′, has pairs of flats 27 spaced 120 degrees apart on each end portion machined thereon for engagement with interior ends 20 of the spaced jacking screws 18 used in a particular application. Magnet array 28 is held in a fixed position via posts 33 and is spaced away from the interior surface 22 of drum 21 by small clearance space or gap 29. Numeral 30 represents the longitudinal axis of shaft 23. Numeral 31 represents the longitudinal axis of sleeve 10 and numeral 32 represents the longitudinal axis of the magnet array 28.

With reference also to FIG. 2, jacking screws 18 are used to align axis 31 to maintain clearance space 29 as drum 21 is rotated by drive apparatus 24 around magnet array 28 as illustrated in FIG. 3. In addition, each sleeve 10 can be adjusted to level out drum 21 at each end plate 35 to prevent tilting. The present sleeve 10 allows for the positioning of the drum 21 with respect to the magnet array 28 without the need to alter the structure of the drum 21. Alternatively, access holes are often formed in endplates 35, which, as discussed hereinabove, is unacceptable particularly in the case of a wet drum system. Preferably, only six alternatively spaced jacking screws 18 (120 degrees apart) are used at each end of shaft 23. The holes 16 not used with a screw 18 are used in conjunction with depth measuring devices or gauges to align the sleeves 10 as desired and are then filled with plugs 38 prior to operation of the apparatus. Bearing covers 26 are affixed to drum endplates 35 via three spaced bolts 37.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

1. Adjustment apparatus for adjusting the clearance between the interior surface of a rotatable drum having spaced end plates connected to a cylindrical shell and a magnet array having an outer surface supported by a fixed shaft having an outer surface in a relatively fixed position and disposed inside such drum, said apparatus comprising a hollow cylindrical sleeve having interior and exterior surfaces and opposite end portions and means for mounting said sleeve between such shaft and one such end plate, said means for mounting including adjustment means carried by said sleeve and located externally of the end plates for varying spatial distance between said interior surface of said sleeve and the outer surface of such shaft for moving the longitudinal axis of such drum relative to the longitudinal axis of such magnet array and to provide a generally uniform clearance space between the interior surface of such drum and an outer surface of such magnet array.

2. The apparatus as defined in claim 1 wherein said sleeve includes a plurality of spaced threaded radially disposed holes extending between said interior and exterior surfaces, said adjustment means including a plurality of elongate screws threaded into said holes and contacting the outer surface of such shaft, each said screw operable inwardly and outwardly in respective said hole to move said sleeve with respect to such shaft for moving the longitudinal axis of such drum.

3. The apparatus as defined in claim 2 wherein such shaft has a plurality of flat surface areas formed on the outer surface thereof for engagement with a respective said screw.

4. The apparatus as defined in claim 1 wherein said means for mounting includes a bearing surface formed on one said end portion of said sleeve for engagement with an end plate for supporting a drum thereon.

5. The apparatus as defined in claim 2 wherein said holes are spaced at approximately 60 degrees apart.

6. The apparatus as defined in claim 1 wherein said sleeve includes a first and second set of spaced radially disposed holes extending between said interior and exterior surfaces, said adjustment means including a plurality of elongate posts located in said first set of holes and contacting the outer surface of such shaft, each installed said posts operable inwardly and outwardly in respective said hole to move said sleeve with respect to such shaft for vertically moving the longitudinal axis of such drum.

7. The apparatus as defined in claim 6 wherein said posts are located in both of said sets of holes for enhanced stability.

8. The apparatus as defined in claim 1 wherein said sleeve includes a first and second set of spaced radially disposed holes extending between said interior and exterior surfaces, said adjustment means including a plurality of elongate threaded screws located in said first set of holes and contacting the outer surface of such shaft, each said screw operable inwardly and outwardly in respective said hole to move said sleeve with respect to such shaft for vertically moving the longitudinal axis of such drum.

9. Adjustment apparatus for adjusting the clearance between the interior surface of a rotatable drum having spaced end plates connected to a cylindrical shell and a magnet array having an outer surface supported by a fixed shaft having an outer surface and opposite end portions in a relatively fixed position and disposed inside such drum, said apparatus comprising a pair of hollow cylindrical sleeves each having interior and exterior surfaces and opposite end portions and means for mounting each said sleeve between one end portion of such shaft and one such end plate, said means for mounting including adjustment means carried by said sleeve and located externally of the end plates for varying spatial distance between said interior surface of said sleeve and the outer surface of a respective end portion of such shaft and for moving the longitudinal axis of such drum relative to the longitudinal axis of such magnet array and to provide a generally uniform clearance space between the interior surface of such drum and an outer surface of such magnet array.

10. The apparatus as defined in claim 9 wherein each said sleeve includes a plurality of spaced threaded radially disposed holes extending between said interior and exterior surfaces, said adjustment means including a plurality of elongate screws threaded into said holes and contacting the outer surface of the end portion of such shaft, each said screw operable inwardly and outwardly in respective said hole to move respective said sleeve with respect to such shaft for moving the longitudinal axis of such drum.

11. The apparatus as defined in claim 10 wherein such shaft has a plurality of flat surface areas formed on the outer surface thereof for engagement with a respective said screw.

12. The apparatus as defined in claim 9 wherein said means for mounting includes a bearing surface formed on one said end portion of each said sleeve for engagement with an end plate for supporting a drum thereon.

13. The apparatus as defined in claim 10 wherein said holes are spaced circumferentially at approximately 60 degrees apart.

14. Adjustment apparatus for adjusting the clearance between an interior surface of a hollow drum rotatably mounted on a shaft having an outer surface, said drum having spaced end plates connected to a cylindrical shell and a magnet array supported by said shaft in a relatively fixed position with respect to said drum and shaft and disposed inside said drum, said apparatus comprising a pair of hollow cylindrical sleeves each having interior and exterior surfaces and opposite end portions and means for mounting respective said sleeve between said shaft and respective said end plates, said means for mounting including adjustment means carried by said sleeve and located externally of said end plates for varying spatial distance between said interior surface of said sleeve and said outer surface of said shaft and for moving the longitudinal axis of said drum relative to the longitudinal axis of said magnet array and to provide a generally uniform clearance space between said interior surface of said drum during its rotation with respect to an outer surface of said magnet array.

15. The apparatus as defined in claim 14 wherein each said sleeve includes a plurality of spaced threaded radially disposed holes extending between said interior and exterior surfaces, said adjustment means including a plurality of elongate screws threaded into said holes and contacting said outer surface of the end portion of said shaft, each said screw operable inwardly and outwardly in respective said hole to move respective said sleeve with respect to said shaft for moving the longitudinal axis of said drum.

16. The apparatus as defined in claim 15 wherein said shaft has a plurality of flat surface areas formed on said outer surface for engagement with a respective said screw.

17. The apparatus as defined in claim 14 wherein said means for mounting includes a bearing surface formed on one said end portion of each said sleeve for engagement with said end plate for supporting said drum thereon.

18. The apparatus as defined in claim 15 wherein said screws are spaced circumferentially at approximately 120 degrees apart.

19. The apparatus as defined in claim 14 wherein said sleeve includes a first and second set of spaced radially disposed holes extending between said interior and exterior surfaces, said adjustment means including a plurality of elongate threaded screws located in said first set of holes and contacting the outer surface of such shaft, each said screw operable inwardly and outwardly in respective said hole to move said sleeve with respect to such shaft for vertically moving the longitudinal axis of such drum.

20. The apparatus as defined in claim 19 wherein said holes in said first and second sets of holes are spaced circumferentially at approximately 120 degrees apart.
